(19) United States
(12) Patent Application Publication
(10) Pub. No.: US 2003/0168111 A1
(43) Pub. Date: Sep. 11, 2003

(54) EGR valve

(75) Inventors: Ryuuichi Koga, Tokyo (JP); Yoshiyuki Nii, Tokyo (JP); Yuuichi Takeuchi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: HINO MOTORS LTD., Tokyo (JP)

(21) Appl. No.: 10/378,916

(22) Filed: Mar. 5, 2003

(30) Foreign Application Priority Data
Mar. 5, 2002 (JP) 2002-059025

(51) Int. Cl. F16K 11/00

(52) U.S. Cl. 137/625.34

(57) ABSTRACT

Disclosed is an EGR valve which is compact in size and can increase an amount of exhaust gas to be recirculated in comparison with that of the prior art without deteriorating mountability of an engine to a vehicle. The EGR valve has a housing with a mounting surface adapted to be mounted to an exhaust gas confluence port on a suction pipe, an gas intake pathway extending through the housing along the mounting surface and having longitudinal ends one of which is opened as gas inlet, gas discharge pathways in the housing for communication with longitudinally spaced portions of the gas intake pathway via openings and opened via gas outlets to the mounting surface, and actuators mounted on the housing for moving valve bodies to selectively open and close the openings.

### BACKGROUND OF THE INVENTION

1. Field of the Invention

The present invention relates to an EGR valve.

2. Related Art of the Invention

Exhaust gas recirculation is generally utilized with respect to an automotive engine. Exhaust gas from the engine is partially returned to the suction side of the engine via an exhaust gas recirculation passage, using pressure difference between the exhaust and suction sides; the exhaust gas thus returned to the suction side suppresses combustion of fuel in the engine, thereby lowering combustion temperature and reducing NOₓ to be generated. Incorporated in the recirculation passage is an EGR valve as exemplarily shown in FIG. 1.

In FIG. 1, reference numeral 1 denotes a housing which constitutes the EGR valve. The housing 1 has a side surface on which both a gas inlet 2 and a gas outlet 3 are opened one above the other, leading to gas intake and discharge pathways 4 and 7, respectively. The gas intake pathway 4 extending to the right in FIG. 1 ends with a dead end and has upper and lower openings 6 selectively opened and closed by upper and lower valve bodies 5. The gas discharge pathway 7 positioned under the lower opening 6 and extending to the right in FIG. 1 turns upward behind the dead end of the intake pathway 4, extends back to the left in FIG. 1 and ends with a dead end positioned over the upper opening 6.

The upper and lower valve bodies 5 are supported by a valve stem 8 vertically and slidably extending through an upper portion of the housing 1, and are adapted to be upwardly fitted into the upper and lower openings 6 from below for closing of the same.

Mounted on the upper portion of the housing 1 is an electromagnetic actuator 9 which actuates the valve stem 8 for its vertical motion to selectively open and close the openings 6 by the valve bodies 5. More specifically, the actuator 9 has a casing or outer shell 10 which vertically movably accommodates a core or iron piece 11 which in turn is fitted to an upper end of the valve stem 8 and is resiliently supported by upper and lower springs 12 and 13. The valve stem 8 can be moved upwardly or downwardly, using electromagnetic force of a liner electromagnetic solenoid 14 surrounding the core 11 in the casing 10.

With the EGR valve thus constructed being arranged in the exhaust gas recirculation passage, the valve bodies 5 can be electrically controlled to selectively open and close the openings 6 for starting and stopping the recirculation of the exhaust gas 15.

Because of inherent limitation in a possible flow rate of the exhaust gas 15 passing through a single EGR valve and in view of severe exhaust gas regulations now and in future and for possible application to an engine with greater displacement, it is conceivable that a plurality of such EGR valves are to be arranged to increase an amount of exhaust gas 15 to be recirculated. However, side-by-side arrangement of such conventional counter-flow type EGR valves each having the gas inlet and outlet 2 and 3 on the same side surface of the housing 1 necessitates an intervening flow-path forming member 19 as shown in FIG. 2 which has a gas passage 16 guiding the exhaust gas 15 to be recirculated in a direction of arrangement of the EGR valves (or in the direction perpendicular to plane of FIG. 2) and distributing it into the respective gas inlets 2 of the EGR valves and has a gas passage 16′ guiding the exhaust gas 15 from the respective EGR valves in a direction substantially perpendicular to that of the gas passage 16 for confluence into an exhaust gas confluence port 18 of a suction pipe 17. Such intervention of the flow-path forming member 19 causes the respective EGR valves to be protruded laterally outwardly of the vehicle (right in FIG. 2), resulting in deteriorated mountability of the engine to a vehicle. Especially in the case of a truck as exemplarily shown in FIG. 2, interference of the EGR valves with a side portion of a cab floor 20 is hard to be averted, leading to probability of greater design restrictions being involved.

In addition, it is to be noted that flow-path connection to the gas inlets and outlets 2 and 3 of the EGR valves is generally carried out upon installation of the EGR valves themselves. It is therefore not practical to dare to carry out complicate piping to the gas inlets and outlets 2 and 3 of the respective EGR valves while the latter are supported by the engine 23 through brackets or the like; moreover, no advantages in space saving could be expected even arranging the EGR valves in such complication. Therefore, if side-by-side arrangement of the EGR valves is to be effected, it naturally takes the form of an arrangement with an intervening flow-path forming member 19 as shown in FIG. 2. In FIG. 2, reference numeral 21 denotes a suction manifold; and 22, sucked air.

### SUMMARY OF THE INVENTION

The invention was made in view of the above and has its object to provide an EGR valve which is compact in size and which can increase an amount of exhaust gas to be recirculated more than is possible in the conventional art and without deteriorating mountability of the engine to a vehicle.

More specifically, the invention is directed to an EGR valve comprising a housing with a mounting surface adapted to be joined to an exhaust gas confluence port on a suction pipe,

a gas intake pathway extending through said housing along said mounting surface and having longitudinal ends one of which is opened as a gas inlet,

gas discharge pathways extending through said housing to communicate with longitudinally spaced portions of said gas intake pathway via openings, each of said gas discharge pathways being opened as a gas outlet to said mounting surface, and

actuator means mounted on said housing for moving valve bodies to selectively open and close said openings.

With the mounting surface of the housing being joined to the exhaust gas confluence port of the suction pipe and with a terminal end of an exhaust gas recirculation passage being connected to the gas inlet of the housing, opening operation of the valve bodies by the actuator means causes the exhaust gas from the exhaust side to be taken via the gas inlet of the housing into the gas intake pathway, the exhaust gas then flowing via the openings, which are on the longitudinally spaced portions of the gas intake pathway and are opened by the opening operation by the valve bodies, into the discharge pathways and is discharged via the gas outlets to the exhaust gas confluence port of the suction pipe.

In the EGR valve thus constructed, merely increasing in number the openings in the longitudinal direction of the gas intake pathway can increase an amount of exhaust gas to be recirculated more than is possible in the conventional art; and moreover, the gas intake and discharge pathways provided by and within the one and single housing enables the exhaust gas introduced in the direction along with the mounting surface of the housing to be distributed into the plural openings so that it is discharged at the mounting surface of the housing to the exhaust gas confluence port of the suction pipe. As a result, any intervening, flow-path forming member is not necessitated with respect to the exhaust gas confluence port of the suction pipe and any protrusion of the EGR valves laterally outwardly of the vehicle is drastically suppressed so that deterioration of mountability of the engine to a vehicle is averted.

A preferred embodiment of the invention will be described in conjunction with the drawings.

### BRIEF DESCRIPTION OF THE DRAWINGS

FIG. 1 is a sectional view showing a conventional EGR valve;

FIG. 2 is a view partly in section showing the EGR valve of FIG. 1 joined to a suction pipe;

FIG. 3 is a perspective view showing an embodiment of the invention;

FIG. 4 is a detailed sectional view showing a housing and actuators of FIG. 3; and

FIG. 5 is a view partly in section showing the EGR valve of FIG. 3 joined to a suction pipe.

### DETAILED DESCRIPTION OF A PREFERRED EMBODIMENT

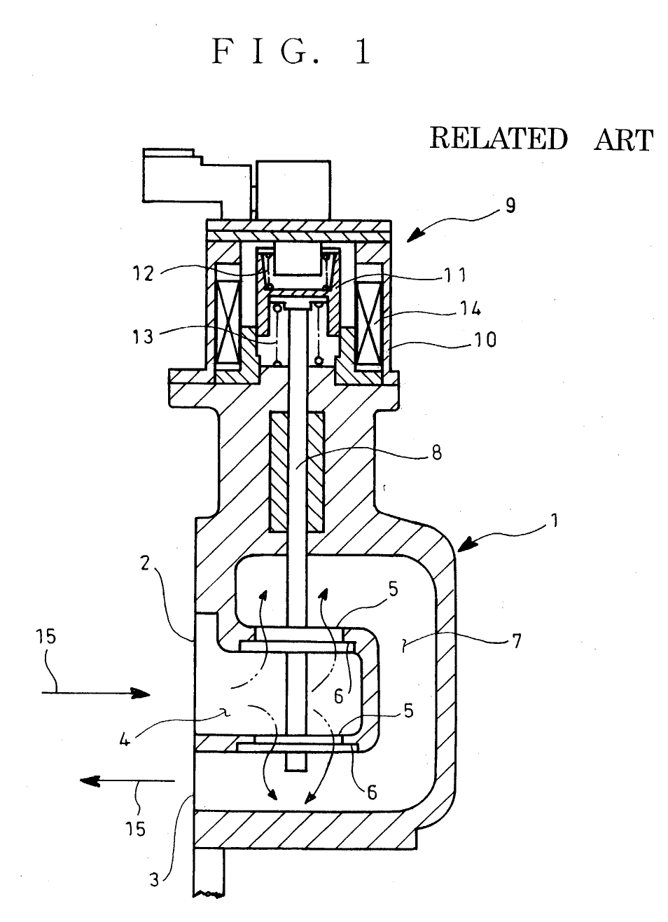

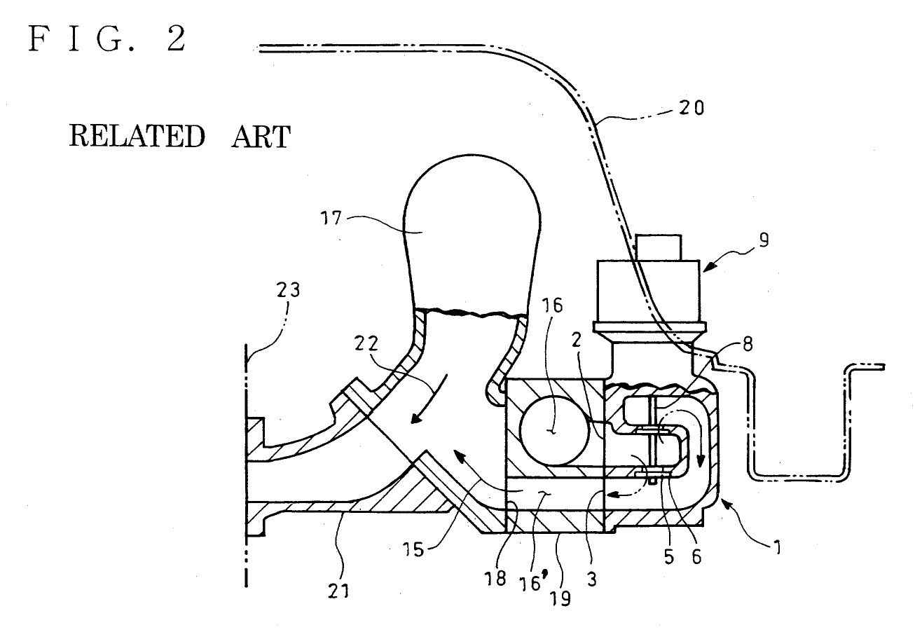

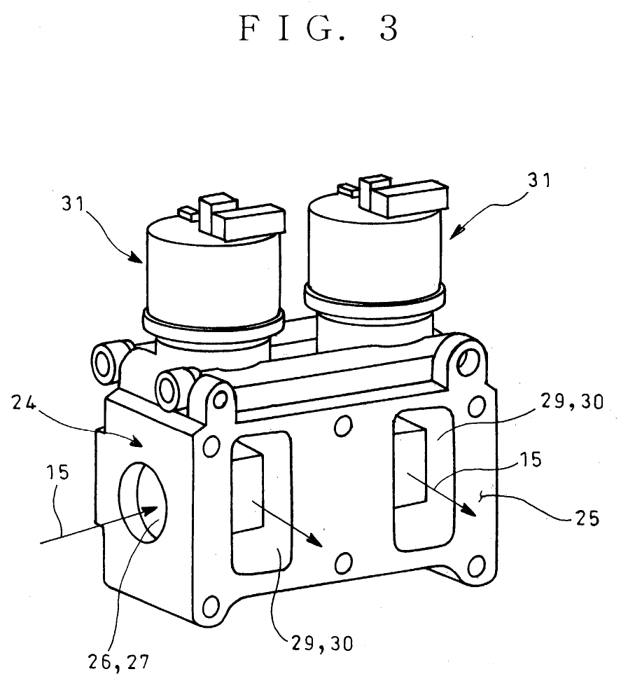

FIGS. 3-5 show an embodiment of the invention where parts similar to those shown in FIGS. 1 and 2 are referred to by the same reference numerals.

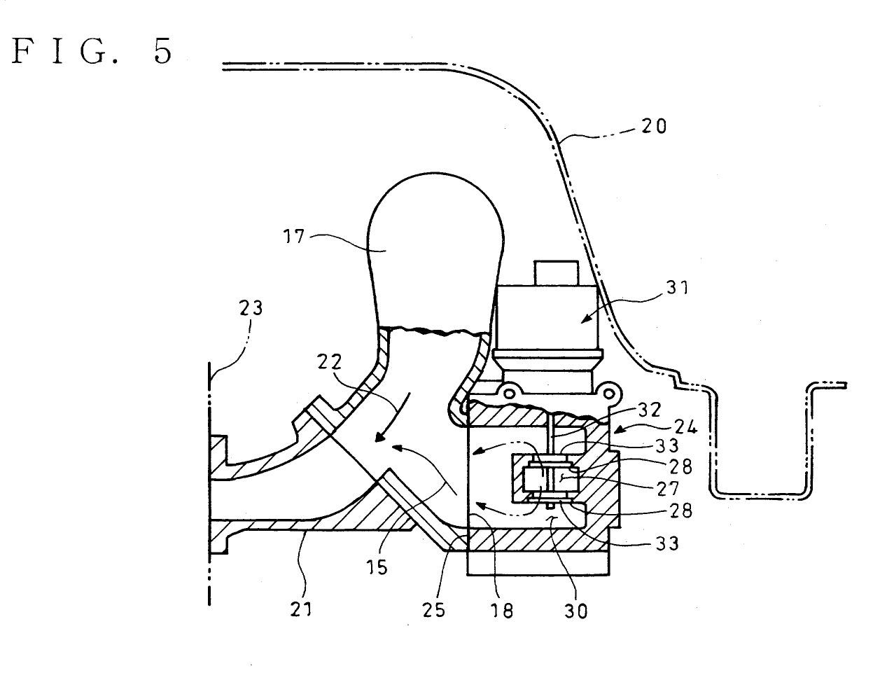

As shown, an EGR valve according to the embodiment comprises a housing 24 having a mounting surface 25 adapted to be joined to an exhaust gas confluence port 18 on a suction pipe 17 (see FIG. 5). Provided within the housing 24 are a gas intake pathway 27 and two gas discharge pathways 30. The gas intake pathway extends in a direction along the mounting surface 25 and has longitudinal ends one of which is opened as a gas inlet 26. The gas discharge pathways 30 are U-shaped in section and communicate with the gas intake pathway 27 at longitudinally spaced two positions via upper and lower openings 28. The gas discharge pathways 30 are opened as gas outlets 29 to the mounting surface 25.

Mounted side-by-side on an upper portion of the housing 24 and along the mounting surface 25 are two actuators 31 which vertically move or urge valve stems 32 which in turn slidably extend through the upper portion of the housing 24. Upper and lower valve bodies 33 on each of the valve stems 32 are selectively moved upwardly to and downwardly away from the corresponding upper and lower openings 28 so that the openings 28 at the two longitudinally spaced positions on the gas intake pathway 27 are selectively opened and closed.

Each of the actuators 31, which is of a basic structure similar to that shown in FIG. 1, has a casing or outer shell 34 within which a core or iron piece 35 fitted to an upper end of the valve stem 32 is vertically movably accommodated and is resiliently supported by vertically extending springs 36 and 37 so that the valve stem 32 can be moved downwardly or upwardly, using electromagnetic force of a linear electromagnetic solenoid 38 which is arranged in the casing 34 to surround the core 35.

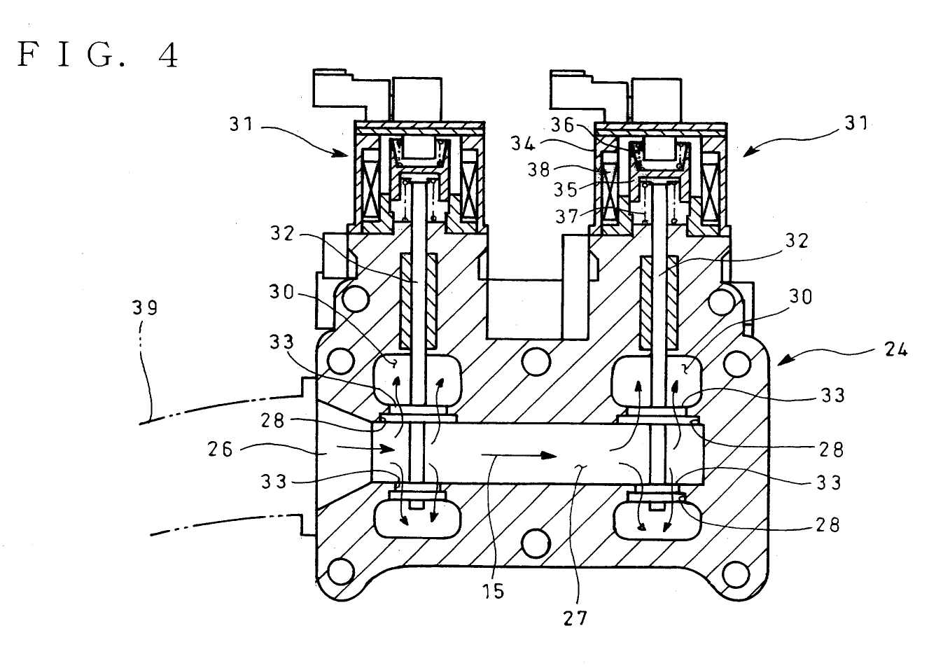

Thus, with the mounting surface 25 of the housing 24 being joined to an exhaust gas confluence port 18 of the suction pipe 17 and with a terminal end of an exhaust gas recirculation passage 39 (see FIG. 4) being connected to a gas inlet 26 of the housing 24, the respective actuators 31 move the corresponding valve stems 32 downward for opening operation of the valve bodies 33. As a result, the exhaust gas 15 from the discharge side enters via the gas inlet 26 of the housing 24 into the gas intake pathway 27 to flow therethrough and further through the gas discharge pathways 30 via the upper and lower openings 28 at the two longitudinal spaced positions of the pathway 27. The exhaust gas 15 is then guided to the gas outlets 29 to be discharged to an exhaust gas confluence port 18 of a suction pipe 17.

In the EGR valve thus constructed, increase in number of the openings 28 in the longitudinal direction of the gas intake pathway 27 can increase an amount of the exhaust gas 15 to be recirculated in comparison with the prior art; moreover, provision of the gas intake and discharge pathways 27 and 30 in the one and single housing 24 causes the exhaust gas 15 introduced in the direction along with the mounting surface 25 of the housing 24 to be distributed into the plural openings 28 and to be discharged at the mounting surface 25 of the housing 24 to the exhaust gas confluence port 18 of the suction pipe 17 so that no intervening flow-path forming member 19 (See FIG. 2) is needed for the exhaust gas confluence port 18 of the suction pipe 17. As a result, protrusion of the EGR valves laterally outward of the vehicle (right in FIG. 5) is remarkably relieved so that the EGR valve, which allows greater amount of exhaust gas 15 to be recirculated, can be made compact in size and any deterioration of mountability of the engine to the vehicle is averted.

Therefore, according to the above-mentioned embodiment, an amount of the exhaust gas 15 to be recirculated is increased in comparison with the prior art without deteriorating mountablity of the engine to the vehicle. Especially in a case of a truck as exemplarily shown in FIG. 5, any interference between a side portion of a cab floor 20 with the EGR valve is averted so that restrictions in designing the EGR valve with increased amount of the exhaust gas 15 to be recirculated can be drastically relieved.

It is to be understood that the invention is not limited to the above-mentioned embodiment and that various changes and modifications may be made without departing from the spirit and scope of the invention.

What is claimed is:

1. An EGR valve comprising a housing with a mounting surface adapted to be joined to an exhaust gas confluence port on a suction pipe,
a gas intake pathway extending through said housing along said mounting surface and having longitudinal ends one of which is opened as a gas inlet,
gas discharge pathways in the housing for communication with longitudinally spaced portions of said gas intake pathway via openings, each of said gas discharge pathways being opened as a gas outlet to said mounting surface, and
actuator means mounted on said housing for moving valve bodies to selectively open and close said openings.
